(19) United States
(12) Patent Application Publication
(10) Pub. No.: US 2026/0167451 A1
(43) Pub. Date: Jun. 18, 2026

(54) APPARATUS FOR MANUFACTURING A STEPPED-BACK MATERIAL

(71) Applicant: Jaco Aerospace Inc., Valencia, CA (US)

(72) Inventor: Yisroel Schusterman, Los Angeles, CA (US)

(73) Assignee: Jaco Aerospace Inc., Valencia, CA (US)

(21) Appl. No.: 18/983,197

(22) Filed: Dec. 16, 2024

(51) Int. Cl. B65H 37/04; B65H 18/02; B65H 18/10; C09J 7/20

(52) U.S. Cl. CPC B65H 37/04; B65H 18/021; B65H 18/10; C09J 7/203; C09J 2301/124

(57) ABSTRACT

An apparatus includes a base, and a guide plate coupled to the base. The guide plate includes a straight portion, and a curved portion extending away from the straight portion and defining a guide plate cavity. The apparatus includes spacers coupled to the base and positioned a distance away from the curved portion of the guide plate. Each of the spacers are rotatably supporting a roll of tape. The apparatus includes guide pins coupled to the base. Each of the guide pins are positioned between a corresponding spacer and the curved portion of the guide plate. The apparatus includes a first roll comprising a first material and is removably coupled to the base and positioned in the guide plate cavity. The apparatus also a second roll removably coupled to the base and positioned adjacent the straight portion and is configured to receive the tape coupled to the first material.

### TECHNICAL FIELD

The present disclosure relates generally to an apparatus for manufacturing a stepped-backed material.

### BACKGROUND

Stepped-back materials, such as an adhesive backed tape, can be used when coating a surface such that each one of the layers can be removed after each of the coatings is applied, facilitating and resulting in a surface coating of varying thickness. Very thick or very fine and highly defined coatings can take time to cure. Adhesive backed tapes that are produced using a step back process are applied to a surface prior to coating the surface and can be left on after the coating has been applied to catch any drippings and facilitate keeping a precise edge of the coating as it dries. Stepped-backed materials can also be used as stencils applying an image to a surface. Each layer of the material can cover a portion of the image, and after paint is applied, a layer can be removed to reveal the portion of the image for the next layer of paint. The process for manufacturing stepped-backed materials like adhesive backed tape can be quite time consuming and often leads to lack of uniformity in the adhesive backed tape. To obtain an adhesive backed tape material requires a stepped-backed process in which a user hand places each of the tape layers on top of a previous layer on top of a backing that allows the adhesive backed tape to then be easily removed for use. Inconsistencies between the layers of the adhesive backed tape can cause potentially damaging results when applying the coating even if the inconsistencies are off by very small amounts. The adhesive backed tape can be used in commercial settings or directly by consumers so there is a need to more efficiently and precisely produce adhesive backed materials of different sizes, shapes, and quantities.

### SUMMARY

In one embodiment, an apparatus includes a base, and a guide plate coupled to a first side of the base. The guide plate includes a substantially straight portion, and a curved portion extending away from a first end of the substantially straight portion and defining a guide plate cavity. The apparatus also includes a plurality of spacers coupled to the first side of the base and positioned a distance away from an outer edge of curved portion of the guide plate. Each of the spacers are rotatably supporting a roll of tape. The apparatus also includes a plurality of guide pins coupled to the first side of the base. Each of the guide pins are positioned between a corresponding spacer and the outer edge of the curved portion of the guide plate. The apparatus also includes a first roll comprising a first material. The first roll is removably coupled to the first side of the base and positioned in the guide plate cavity. The first roll is configured to receive tape. The apparatus also includes a second roll removably coupled to the first side of the base and positioned adjacent to a second end of the straight portion. The second roll is configured to receive the tape coupled to the first material.

In another embodiment, a method of manufacturing includes a stepped-backed material. The method includes providing a portion of a first tape roll to a first material at a first height, coupling the portion of the first tape roll to the first material by feeding each of the first tape roll and the first material between a first guide pin and a guide plate, providing a portion of a second tape roll to the first material at a second height, coupling the portion of the second roll of tape to the first material by feeding each of the second tape roll and the first material comprising the portion of the first tape roll between a second guide pin and the guide plate, and receiving, by a pin, the first material comprising each of the portion of the first tape roll and the portion of the second tape roll.

In another embodiment, an apparatus includes a first roll of backing material, a guide plate surrounding a portion of the first roll, a plurality of rolls of tape spaced around the guide plate, and a second roll configured to receive a first end of the first roll of backing material. The second roll is coupled to a motor that is configured to rotate the second roll. The rotation of the second roll pulls the backing material from the first roll and tape from each of the plurality of rolls of tape into contact with the backing material of the first roll.

### BRIEF DESCRIPTION OF THE FIGURES

The invention will become more fully understood from the following detailed description, taken in conjunction with the accompanying drawings, in which:

FIG. 1 is a perspective view of a system including an apparatus for manufacturing a stepped-backed material, according to an embodiment.

FIG. 2 is a front view of the apparatus of FIG. 1, according to an embodiment.

FIG. 3 is a back view of the apparatus of FIG. 1, according to an embodiment.

FIG. 4 is a top view of the apparatus of FIG. 1, according to an embodiment.

FIG. 5 is a bottom view of the apparatus of FIG. 1, according to an embodiment.

FIG. 6 is a left side view of the apparatus of FIG. 1, according to an embodiment.

FIG. 7 is a right side view of the apparatus of FIG. 1, according to an embodiment.

FIG. 8 is a front view of a stepped-backed material manufactured by the apparatus of FIG. 1.

FIG. 9 is a perspective view of a base of the apparatus of FIG. 1, according to an embodiment.

FIG. 10A is a perspective view of a first spacer of the apparatus of FIG. 1, according to an embodiment.

FIG. 10B is a perspective view of a second spacer of the apparatus of FIG. 1, according to an embodiment.

FIG. 11A is a perspective view of a first guide pin of the apparatus of FIG. 1, according to an embodiment.

FIG. 11B is a perspective view of a second guide pin of the apparatus of FIG. 1, according to an embodiment.

FIG. 12 is a perspective view of a tensioner of the apparatus of FIG. 1, according to an embodiment.

FIG. 13 is a perspective view of a motor of the apparatus of FIG. 1, according to an embodiment.

FIG. 14A is a perspective view of a gripper assembly of the apparatus of FIG. 1, according to an embodiment.

FIG. 14B is another perspective view of the gripper assembly of the apparatus of FIG. 14A, according to an embodiment.

FIG. 14C is another perspective view of the gripper assembly of the apparatus of FIG. 14A, according to an embodiment.

FIG. 15 is a front view of an apparatus, according to another embodiment.

FIG. 16 is a perspective view of the apparatus of FIG. 15, according to an embodiment.

FIG. 17 is a front view of an apparatus, according to another embodiment.

FIG. 18 is a perspective view of the apparatus of FIG. 17, according to an embodiment.

FIG. 19 is a perspective view of an apparatus, according to another embodiment.

FIG. 20 is a top view of a system including an apparatus, according to another embodiment.

FIG. 21 is a top view of a system including an apparatus, according to another embodiment.

FIG. 22 is a side view of the apparatus of FIG. 21, according to an embodiment.

FIG. 23 is another side view of the apparatus of FIG. 21, according to an embodiment.

FIG. 24 is a top view of an adhesive backed tape including a stencil, according to one embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Implementations herein relate to an apparatus and method for manufacturing a stepped-backed material, such as a stepped-backed material including an adhesive such as a tape. In some instances, it is desired to apply a material, such as a paint or a coating, to a surface such that the thickness of the paint or coating varies along the surface. For example, in the aerospace industry it is desirable to paint a surface (e.g., a wing, etc.) of an aircraft such that the thickness of the paint tapers down (e.g., decreases, etc.) towards an edge of the surface. Thus, it is advantageous to use a layer material including an adhesive such that the stepped-backed material can be removably coupled to the surface and removed layer by layer as sequential coatings of paint are applied to the surface.

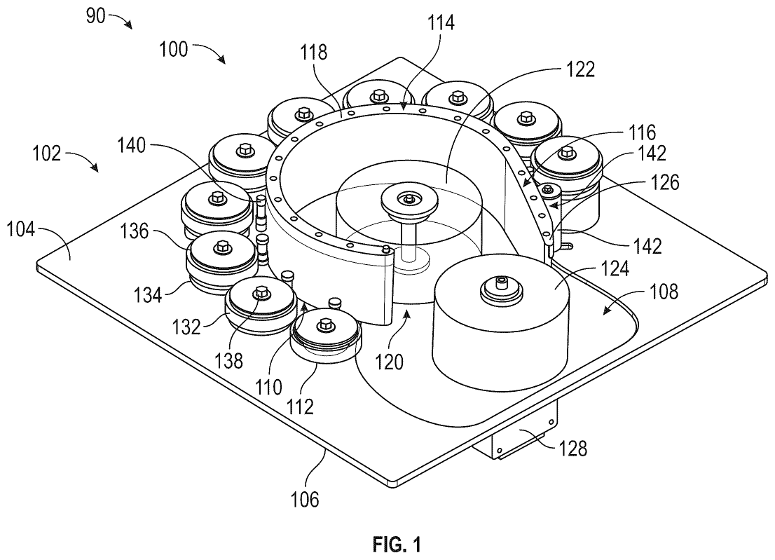

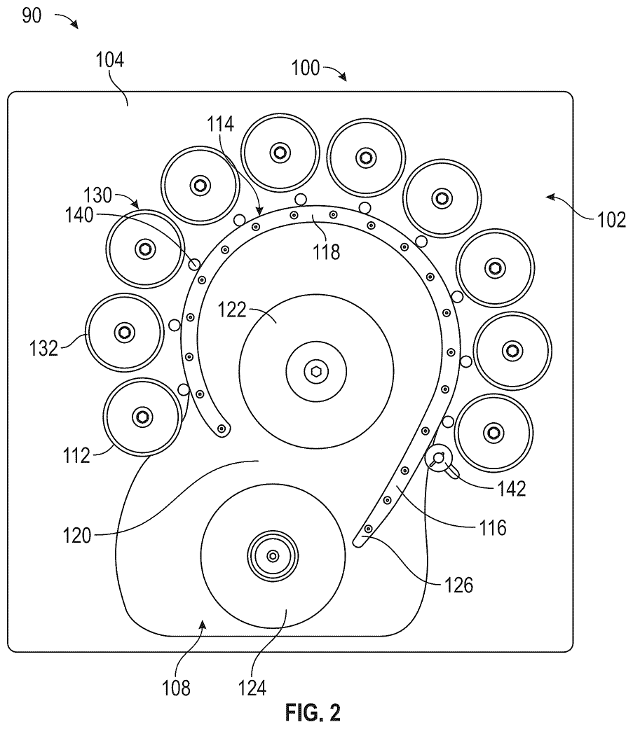

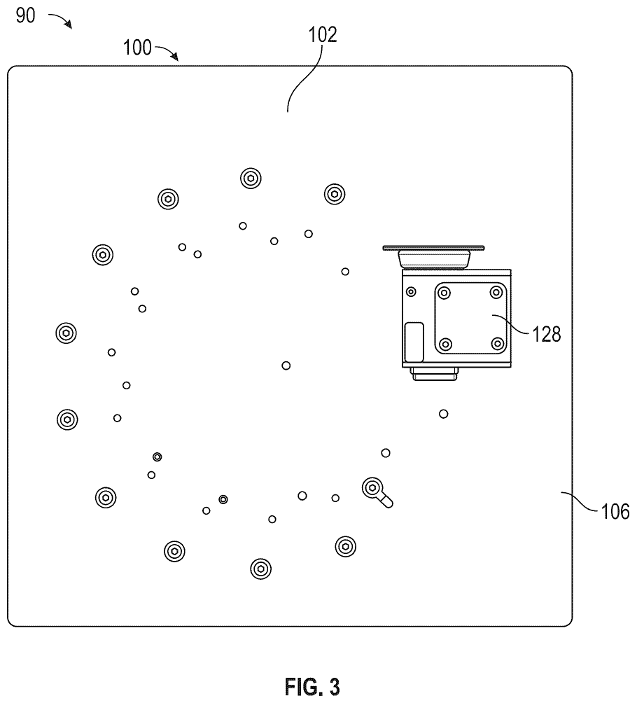

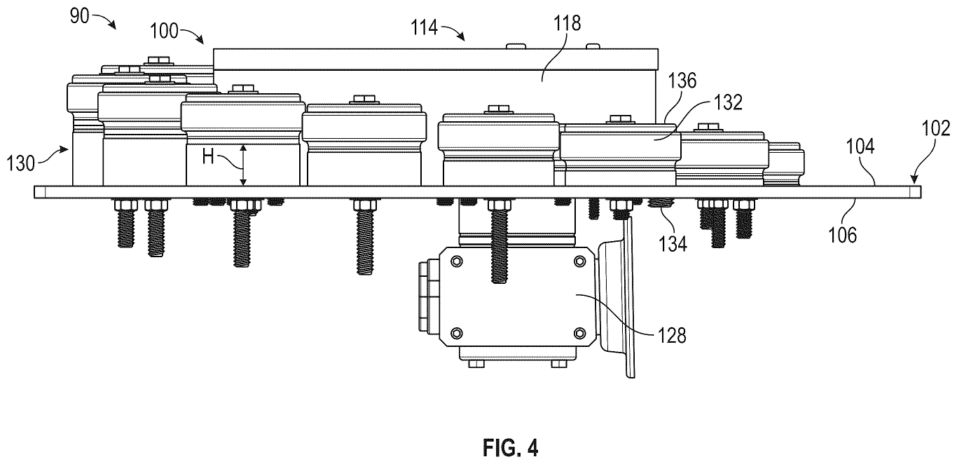

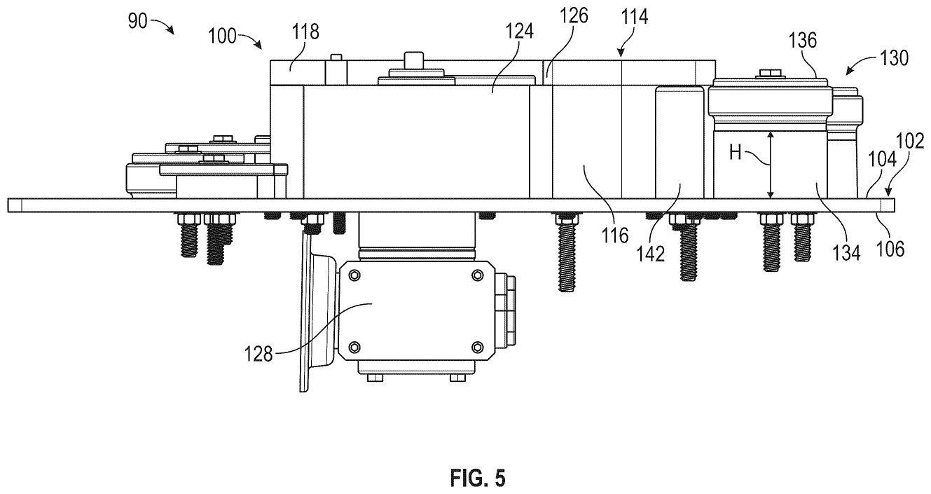

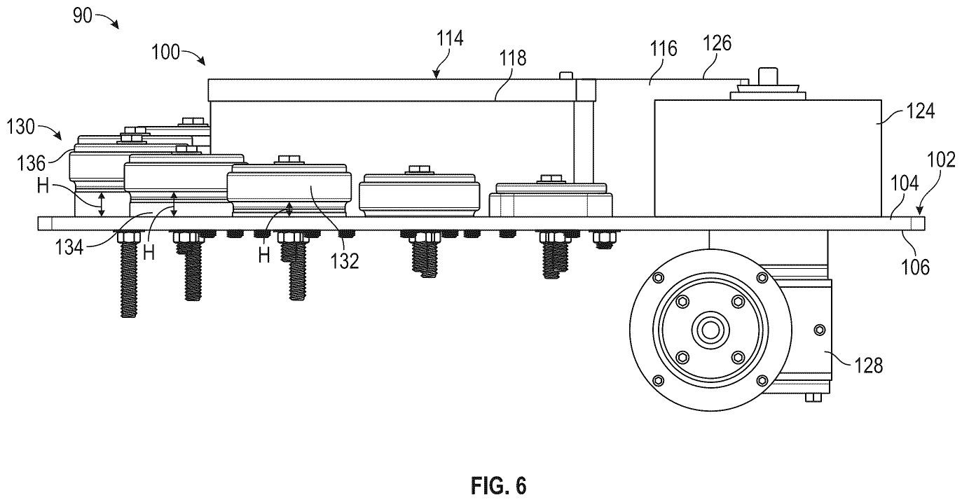

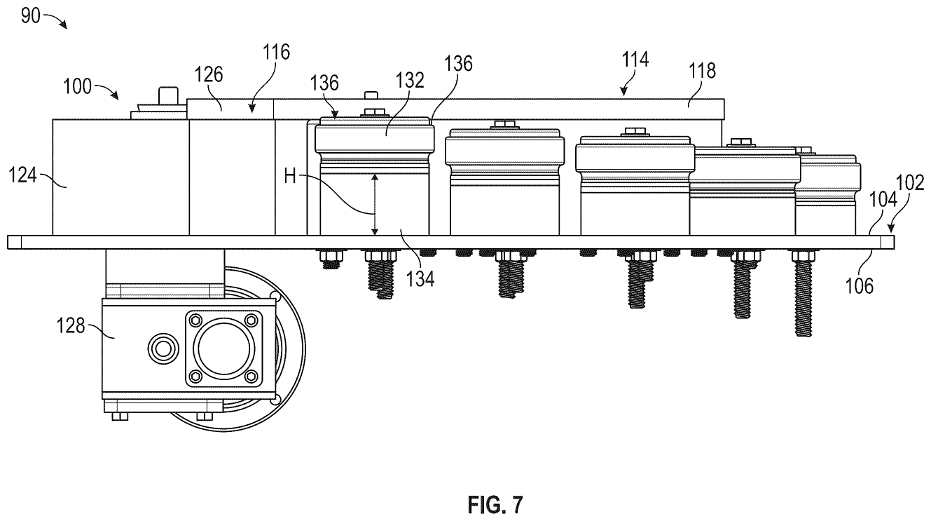

FIGS. 1-7 are various views of a system 90 including the apparatus 100. The apparatus 100 includes a base 102. The base 102 is substantially square in shape, but other shapes are possible (e.g., rectangular, circular, etc.). According to this embodiment, the base 102 is metal. In other materials the base 102 can be plastic, wood, or other rigid materials.

The base 102 has a first side 104 and a second side 106. The second side 106 is positioned opposite the first side 104. According to this embodiment, the first side 104 is a top side and the second side 106 is a bottom side.

The first side 104 of the base 102 includes a first recessed portion 108 (e.g., a first impression, a first indent, etc.). The first recessed portion 108 is substantially centered on the base 102 and extends towards a first edge (e.g., a bottom edge, etc.) of the base 102. The first recessed portion 108 is configured to receive various components of the apparatus 100 as described in more detail below. According to this embodiment, the first recessed portion 108 is shaped (e.g., formed, etc.) to mimic the shape of the various components positioned within the first recessed portion 108 as described in more detail below. For example, the first recessed portion 108 includes a curved recess 110.

The first side 104 of the base 102 also includes a plurality of second recessed portions 112. The plurality of second recessed portions 112 are positioned around (e.g., adjacent to, etc.) the curved recess 110 of the first recessed portion 108. According to this embodiment, the second recessed portions 112 are circular in shape. In other embodiment, the second recessed portions 112 are another shape, such a square, rectangle, oval, but are not limited thereto. According to this embodiment, the second recessed portions 112 have varying diameters. For example, a first amount of the second recessed portions 112 (e.g., seven, eight, nine, etc.) have substantially the same diameter, and a second amount of the second recessed portions 112 have a different diameter (e.g., a smaller diameter that the first amount, etc.). In other embodiments, the second recessed portions 112 have substantially the same diameter.

The apparatus 100 includes a guide plate 114. The guide plate 114 is coupled to the base 102. For example, the guide plate 114 may include a dowel or fastener configured to press into an aperture of the base 102. The guide plate 114 is positioned within the first recessed portion 108, and more specifically positioned within the curved recess 110 of the first recessed portion 108. The guide plate 114. According to this embodiment, the guide plate 114 is comprised of a metal, but in other embodiments the guide plate 114 may comprise of another material, such as plastic, but is not limited thereto. The guide plate 114 is configured to guide a backing material (e.g., a first material, a backing material, etc.) substantially perpendicular to the base 102 as tape (e.g., layers of tape, etc.) are removably coupled to (e.g., stuck to, etc.) the backing material.

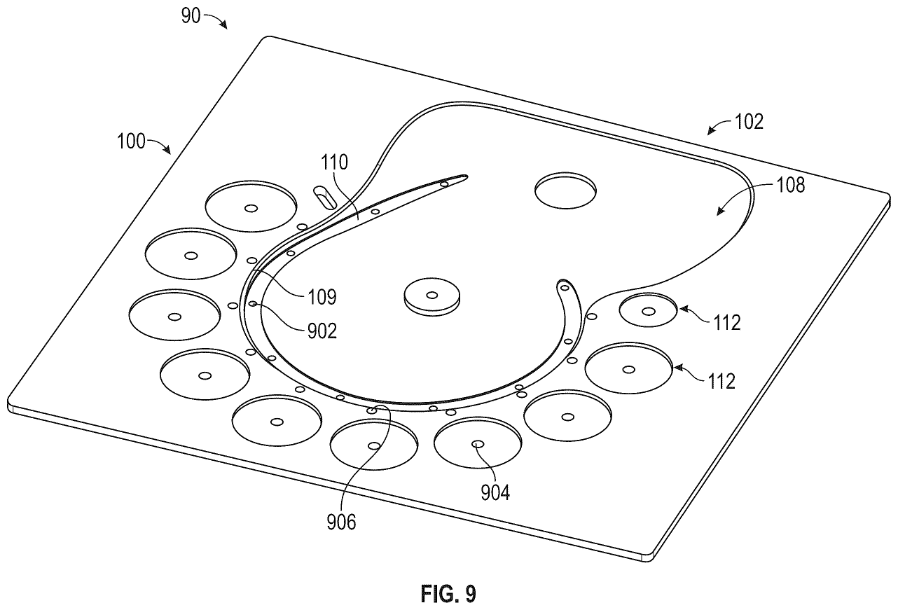

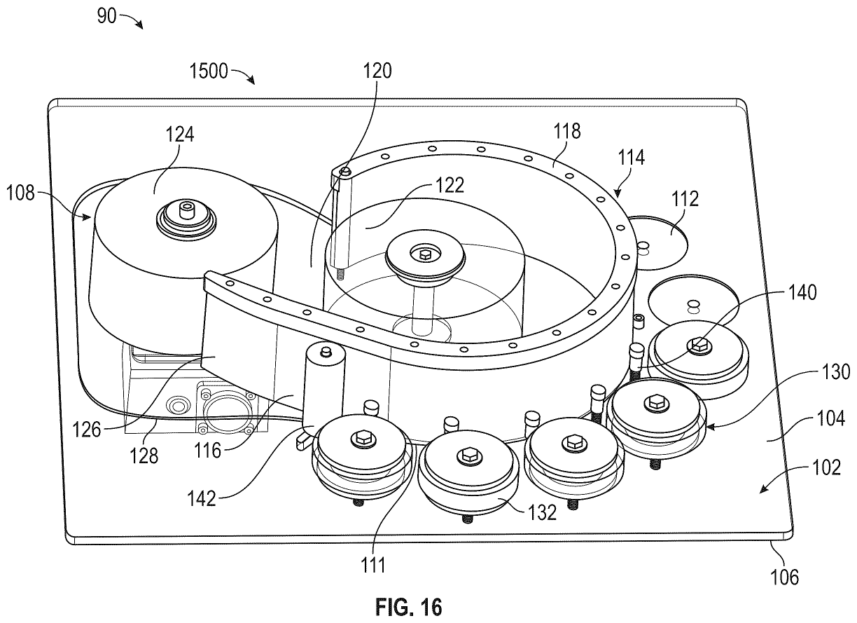

The guide plate 114 includes a straight portion 116 (e.g., substantially straight portion, within plus or minus 10 degrees of 180 degrees, etc.) and a curved portion 118. The guide plate 114 defines a guide plate cavity 120 (e.g., defined by the interior sides of each of the straight portion 116 and the curved portion 118). The curved portion 118 extends away from a first end of the straight portion 116. As shown in FIG. 9, an outer perimeter of the curved recess 110 is less than the outer perimeter of the first recessed portion 108, forming ledge 109, such that when the guide plate 114 is installed, a channel 111 is formed to receive a bottom edge of the backing material 802 as shown in FIG. 16. The channel 111 encourages the backing material 802 to follow the curve of the guide plate 114 and provides a border of backing material below the first applied layer of tape. Referring back to FIGS. 1-7, according to this embodiment, the guide plate 114 is positioned substantially centrally on the base 102 and is positioned within the curved recess 110. For example, an outer edge of the curved portion 118 is adjacent to (e.g., parallel to, etc.) an edge of the curved recess 110 such the channel 111 is between the outer edge of the guide plate 114 and the curved recess 110 for the backing material to pass through (e.g., be guided through, etc.) as it is pulled from the first roll 122 to the second roll 124. For example, the backing material from the first roll 122 is pulled around the guide plate 114 in the channel 111 and coupled to the second roll 124 such that a portion of the backing material is coupled to the second roll 124 prior to any tape being coupled to the backing material (e.g., an initial border is provided, etc.). The curved portion 118 is configured to receive a portion of the baking material (e.g., the paper backing material, the first material, etc.) from a first roll 122. The first roll 122 is positioned within the guide plate cavity 120 and is at least partially surrounded by the curved portion 118. The first roll 122 is removably coupled to the base 102. For example, the first roll 122 can be slid onto a dowel or a pin such that the first roll 122 can be replaced with a new roll of backing material or a roll including a different type of backing material.

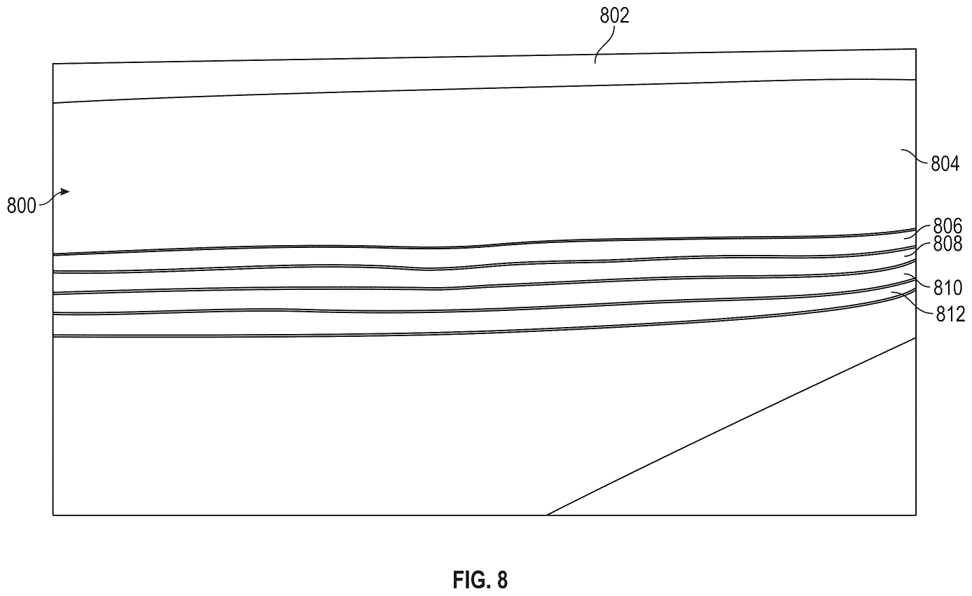

The straight portion 116 is configured to guide the stepped-backed material, such as stepped-backed material 800 described in further detail below in FIG. 8 (e.g., the layers of tape coupled to the backing material, etc.), onto a second roll 124 (e.g., a receiving roll, a final product roll, etc.). The straight portion 116 includes a tapered end 126. The tapered end 126 is opposite the first end that the curved portion 118 extends from. The tapered end 126 facilitates guiding the stepped-backed material onto the second roll 124.

The second roll 124 is removably (e.g., releasably coupled to, etc.) the base 102 within the first recessed portion 108. For example, the second roll 124 is removably coupled such that a new second roll 124 can be coupled to the base 102 when the second roll 124 has reached a capacity for storing the stepped-backed material. The second roll 124 is positioned near (e.g., adjacent to, etc.) a bottom end of the base 102 outside of the guide plate cavity 120. The second roll 124 is positioned such that the tapered end 126 is adjacent to the second roll 124 such that a distance from which the stepped-backed material travels from the tapered end 126 to the second roll 124 is minimized.

The apparatus 100 also includes a motor 128. The motor 128 is coupled to the second side 106 of the base 102 and aligned with the second roll 124 (e.g., positioned axially aligned with the second roll 124, etc.). The motor 128 includes a gripper assembly, described in greater detail below, that extends through the base 102 and removably couples the second roll 124 to the base 102. The motor 128 is configured to provide power (e.g., torque, etc.) to the gripper assembly rotating the gripper assembly and the second roll 124 to wind (e.g., roll, etc.) the stepped-backed material onto the second roll 124. Rotation of the second roll 124 further pulls the backing material from the first roll 122 and tape from each of the plurality of rolls of tape into contact with the backing material of the first roll.

The apparatus 100 further includes a plurality of spacers 130. The plurality of spacers 130 are removably coupled to the first side 104 of the base 102. The spacers 130 are positioned around the curved portion 118 of the guide plate 114, such that the spacers 130 are positioned in a circular (e.g., a portion of a circular arrangement, a hemi-circular arrangement, etc.) arrangement around the curved portion 118. The spacers 130 are positioned within the second recessed portions 112 and are positioned a distance (e.g., an inch, half an inch, a quart of an inch, etc.) away from an outer edge of the curved portion 118 of the guide plate 114. Each of the spacers 130 are configured to receive (e.g., removably couple to, etc.) a roll of tape 132, rotatably supporting (e.g., rotatably coupling, movably coupling, etc.) the roll of tape 132 to the apparatus 100.

According to this embodiment, the apparatus 100 includes ten spacers. The spacers 130 are removably coupled such that any desirable number of spacers 130 may be coupled to the base 102. For example, a user may remove one or more of the spacers 130 such that the apparatus 100 includes fewer spacers 130 (e.g., seven, eight, nine, etc.,) and thus fewer rolls of tape facilitating a stepped-backed material including fewer layers of tape. In other embodiments, the apparatus 100 may include more than ten spacers 130. As such, the spacers 130 may be positioned such that there is a space (e.g., an empty spacer, at least one empty second recessed portion 112, etc.) between spacers 130.

Each of the spacers 130 include a raised portion 134 and a spacer recessed portion 136. The raised portion 134 extends away from a bottom end of the spacer 130 (e.g., an end adjacent to the first side 104 of the base 102, etc.). The raised portion 134 defines a raised portion diameter and a raised portion height H. According to this embodiment, each of the spacers 130 defines a different raised portion height H. As shown in FIGS. 1-7, the raised portion height H of each of the spacers 130 increases (e.g., incrementally, etc.) from a first spacer 130 positioned adjacent to a first end of the curved portion 118 (e.g., an end opposite the end extending from the straight portion 116, etc.) to a second spacer 130 positioned adjacent to the straight portion 116 (e.g., the raise portion height H of the spacers 130 increases when moving in a direction clockwise around the curved portion 118, etc.). In other embodiments, the raised portion height H of each of the spacers 130 may decrease when moving in a direction clockwise around the curved portion 118. In other embodiments, the raised portion height H of the spacers 130 may vary in any other combination, for example such that a first spacer 130 has a first raised portion height H and a second spacer 130 adjacent to the first spacer 130 may have a second raised portion height H greater than the first raised portion height H, and a third spacer 130 adjacent to the second spacer 130 may have a third raised portion height H that is less than the second raised portion height H but greater than the first raised portion height H. It should be noted that other combinations of spacers 130 of varying heights H may be used without departing from the scope of the invention.

The spacer recessed portion 136 is defined from a top end of the spacer 130 (e.g., an end opposite the end adjacent to the base 102, etc.) to the raised portion 134 and defines a recessed portion diameter. The diameter of the spacer recessed portion 136 is less than the diameter of the raised portion 134. The spacer recessed portion 136 is configured to receive the roll of tape 132 such that the roll of tape 132 may contact the raised portion 134. For example, the raised portion height H of the raised portion 134 determines the height at which the tape is applied (e.g., fed onto, etc.) the stepped-backed material.

Each of the spacers 130 define a spacer cavity 138 through a central axis (e.g., a vertical axis, a longitudinal axis, etc.) of the spacer 130. The spacer cavity 138 is configured to receive a pin or fastener coupling the spacer 130 to the base 102. For example, the spacer cavity 138 may receive the pin and the pin may then be press fit into an opening defined by the base 102.

The apparatus 100 also includes a plurality of guide pins 140. The plurality of guide pins 140 are coupled to the first side 104 of the base 102. Each of the guide pins 140 is positioned a pin distance away from a corresponding spacer 130 and the outer edge of the curved portion 118 of the guide plate 114. The pin distance may be the same or vary for each pair of spacers 130 and guide pin 140. For example, a number (e.g., amount, etc.) of guide pins 140 corresponds (e.g., is the same as, etc.) to a number of spacers 130. For example, the apparatus 100 includes ten spacers 130 and ten guide pins 140. The guide pins 140 are configured to guide and direct a portion of the tape as the tape is decoupled from (e.g., unrolled from, etc.) the roll of tape 132 onto the backing material. As such, each of the guide pins 140 defines a pin height P that corresponds to the raised portion height H of the raised portion 134 of the corresponding spacer 130.

The apparatus also includes a tensioner 142. The tensioner 142 is adjustably and rotatably coupled to the first side 104 of the base 102 and is positioned adjacent to the straight portion 116 of the guide plate 114. The tensioner is positioned a distance (e.g., a distance less the distance between the guide pins 140 and the curved portion 118, etc.) such that the stepped-backed material (e.g., the backing material and a plurality of layers of tape, etc.) can pass between the tensioner 142 and the guide plate 114. The tensioner 142 is configured to apply an amount of pressure (e.g., force, etc.) to the stepped-backed material against the straight portion 116 of the guide plate 114. As such, the position of the tensioner 142 is adjustable such that the distance between the tensioner 142 and the straight portion 116 of the guide plate 114 may be changed, thus adjusting the amount of force applied to the stepped-backed material and/or accommodating for different thickness of a stepped-backed material. For example, as the tensioner 142 is moved away from the guide plate 114 (e.g., the distance is increased, etc.) the forces applied by the tensioner 142 to the stepped-backed material on the guide plate 114 is decreased.

The tensioner 142 is rotatably coupled to the base 102 such that the tensioner 142 can rotate and provide point pressure to the stepped-backed material as the stepped-backed material passes between the tensioner 142 and the guide plate 114. For example, the tensioner 142 may be removably coupled to a pin that is press fit into the base 102.

FIG. 8 illustrates a front view of a stepped-backed material 800 manufactured by the apparatus 100 is shown, according to some embodiments. The stepped-backed material 800 includes a backing material 802 and a plurality of layers of tape 804, 806, 808, 810, 812. According to this embodiment, the backing material 802 is a paper backing material. In some embodiments, the backing material 802 comprises a coating such that the layers of tape 804, 806, 808, 810, 812 can be removably coupled to the backing material 802 such that the adhesive of the tape 804, 806, 808, 810, 812 is not disruptive (e.g., the tape maintains adhesive integrity, etc.).

As shown in FIG. 8, each of the layers of tape 804, 806, 808, 810, 812 are offset from adjacent layers of tape 804, 806, 808, 810, 812. According to this embodiment, each of the layers of tape 804, 806, 808, 810, 812 are offset by a distance D (e.g., about an eighth of an inch, etc.). The offset of the layers of tape 804, 806, 808, 810, 812 corresponds to the differences in the raised portion height H of each of the spacers 130. As such, according to the embodiment of FIGS. 1-7, each of the spacers 130 has a raised portion height H incrementally about an eighth of an inch greater than an adjacent spacer 130 when moving clockwise around the curved portion 118. In other embodiments, the offset of each of the layers of tape 804, 806, 808, 810, 812 can be different (e.g., a fourth of an inch, a sixth of an inch, half an inch, etc.). While the offset distance D for each layer of tape 804, 806, 808, 810, 812 is shown as being consistent between each layer of tape 804, 806, 808, 810, 812, in some embodiments, the offset between layers of tape 804, 806, 808, 810, 812 may be non-uniform, such that the offset between tape 804 and 806 is different from the offset between tape 806 and 808. A user may remove the backing material 802 from the layers of tape 804, 806, 808, 810, 812 and apply the layers of tape 804, 806, 808, 810, 812 to a surface (e.g., an aircraft wing, etc.). For example, the user may provide a plurality of coatings to the surface and successively remove one of the layers of tape 804, 806, 808, 810, 812 between apply each coating such that the coating tapers (e.g., decreases, etc.) in thickness.

FIG. 9 illustrates is a perspective view of the base 102. According to this embodiment, the curved recess 110 has a greater depth than the rest of the first recessed portion 108 and is formed to receive the guide plate 114. As shown in FIG. 9, the base 102 includes a plurality of guide plate apertures 902, a plurality of spacer aperture 904, and plurality of pin apertures 906 each configured to receive and removably couple the guide plate 114, the spacers 130, and the guide pins 140, respectively.

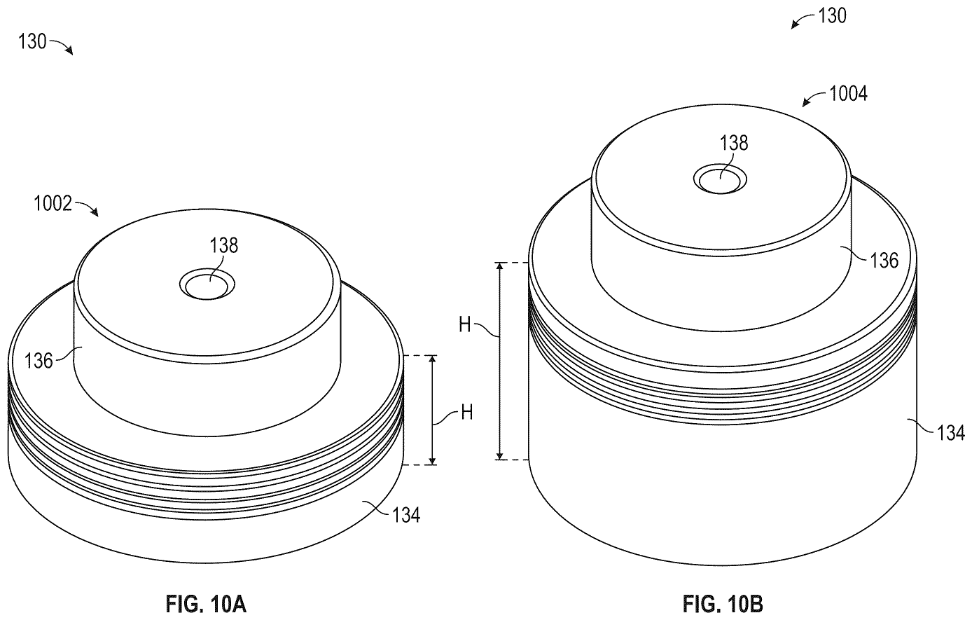

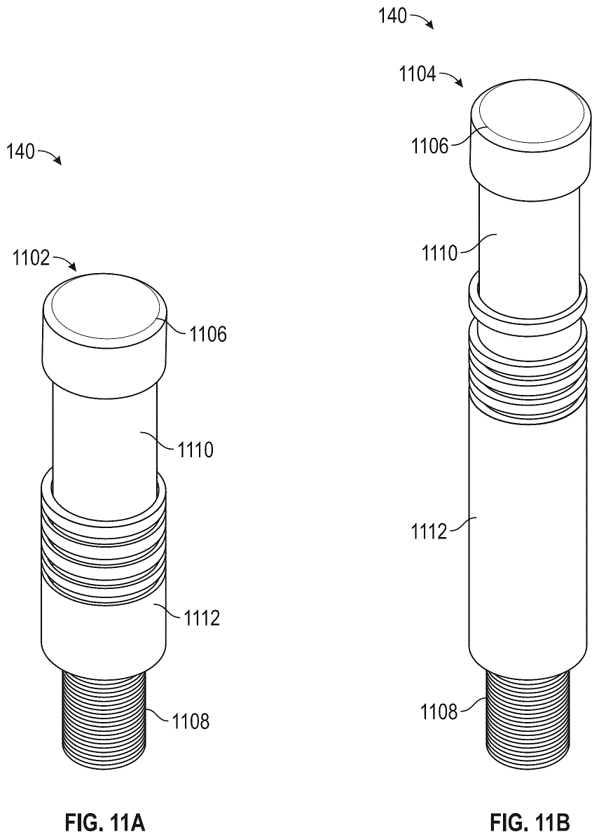

FIGS. 10A and 10B are illustrations of a first spacer 1002 and a second spacer 1004 of the plurality of spacers 130. As shown in FIGS. 10A-10B, the second spacer 1004 has a greater raised portion height H than the first spacer 1002. The spacers 130 are configured such that a roll of tape can be positioned around the spacer recessed portion 136 and in contact with the raised portion 134 by sliding a center opening of the roll of tape onto the spacer 130. As such, the spacers 130 can accommodate a plurality of dimensions and sizes of rolls of tape. Each spacer 130 has one or more grooves 135 in the raised portion 134. In some embodiments, the grooves 135 may allow for identification of each of the spacers 130 and the spacer 130's corresponding location in the apparatus 100 for a specific location, which is determined and dependent on the resultant step-backed material to be produced by the apparatus 100. [0058] FIGS. 11A and 11B illustrate a first guide pin 1102 and a second guide pin 1104 of the plurality of guide pins 140. Each of the guide pins 140 define a guide pin height G corresponding to, or proportional to each of the raised portion heights H of the spacers 130. For example, the first guide pin 1102 can correspond to the first spacer 1002 and the second guide pin 1104 can correspond to the second spacer 1004.

Each of the guide pins 140 include a cap 1106 and a screw portion 1108 on an end opposite the cap 1106. The screw portions 1108 are configured to couple the guide pins 140 to the base 102. The guide pins 140 also include a guide pin recessed portion 1110 and a guide pin raised portion 1112. The guide pin recessed portion 1110 extends from the cap the guide pin raised portion 1112. The guide pin raised portion 1112 extends from the guide pin recessed portion 1110 to the screw portion 1108. The cap 1106 is configured to guide the tape into the guide pin recessed portion 1110, and the guide pin recessed portion 1110 is configured to receive the tape and guide and the tape onto the backing material (e.g., backing material 802, etc.). Each guide pin 140 has one or more grooves 1113 in the guide pin raised portion 1112. In some embodiments, the grooves 1113 may allow for identification of each of the guide pins 140 and the guide pin 140's corresponding location in the apparatus 100 for a specific configuration, which is determined and dependent on the resultant step-backed material to be produced by the apparatus 100.

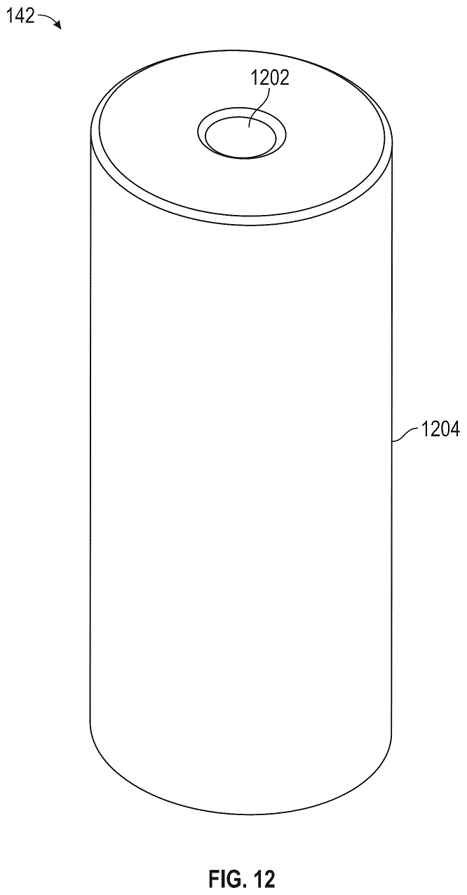

FIG. 12 is a perspective view of the tensioner 142. The tensioner 142 is substantially cylindrical in shape. The tensioner 142 includes a tensioner cavity 1202 defined along a center axis (e.g., a longitudinal axis, etc.) of the tensioner 142. The tensioner cavity 1202 is configured to receive a pin or other type of fastener coupling the tensioner 142 to the base 102 as previously described.

The tensioner 142 includes a contact surface 1204 (e.g., a curved surface, a roller surface, etc.). According to this embodiment, the contact surface 1204 is smooth and firm such that the contact surface 1204 applies (e.g., exerts, etc.) a force to the stepped-backed material (e.g., stepped-backed material 800, etc.) facilitating the coupling of the layers of tape 804, 806, 808, 810, 812 to the backing material 802. In other embodiments, the contact surface 1204 may be textured (e.g., knurled, grooved, etc.) to increase friction between the contact surface 1204 and the stepped-backed material 800.

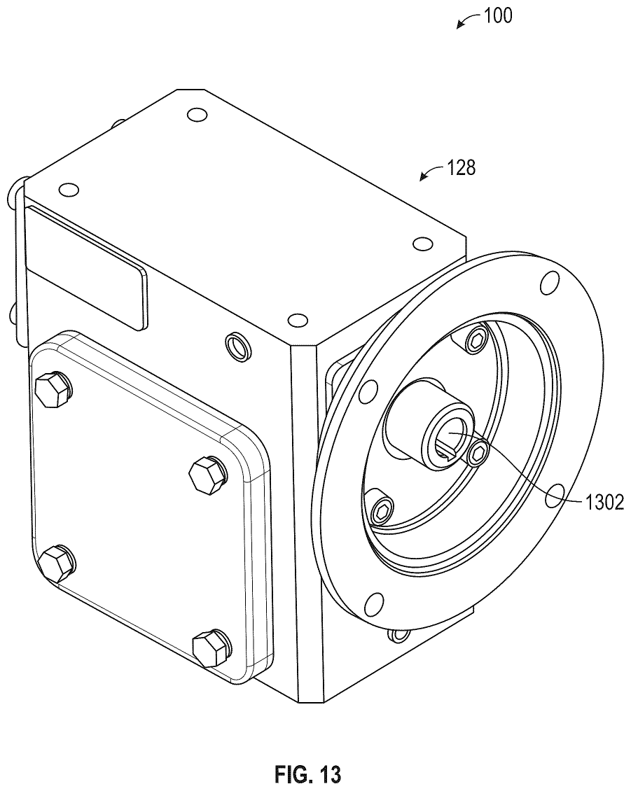

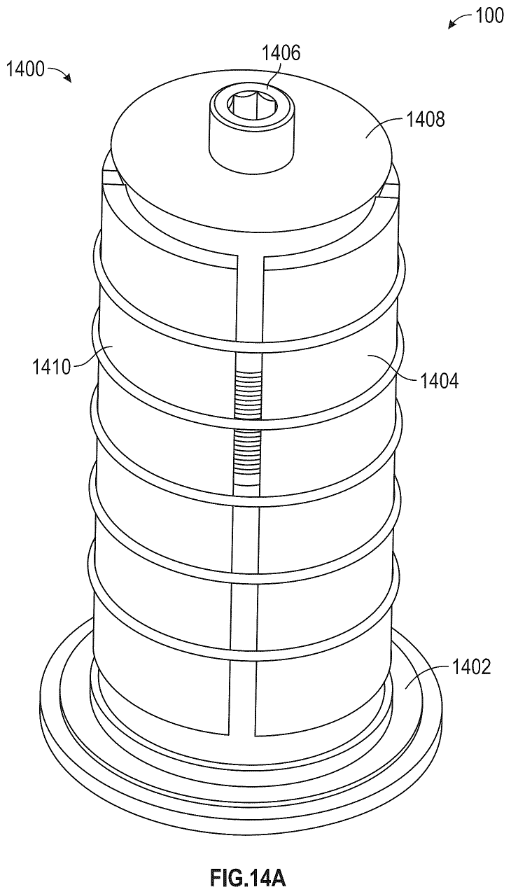

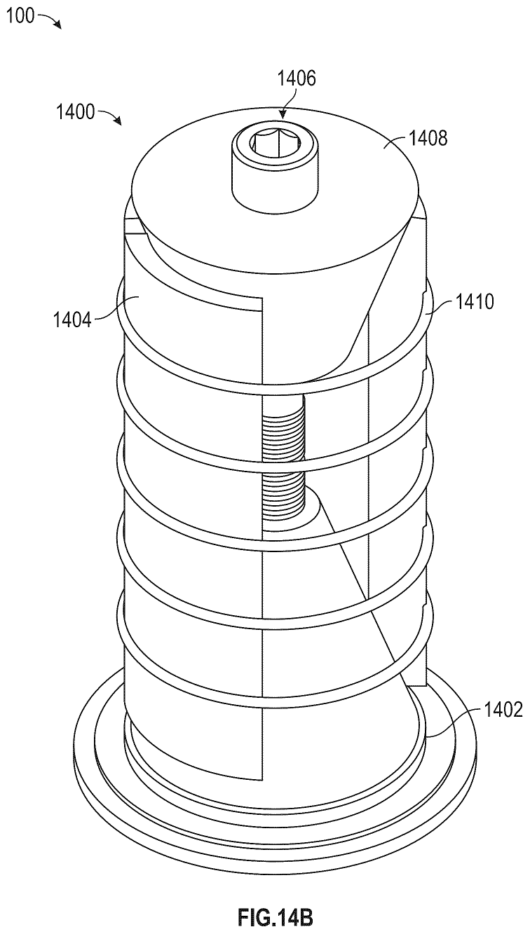

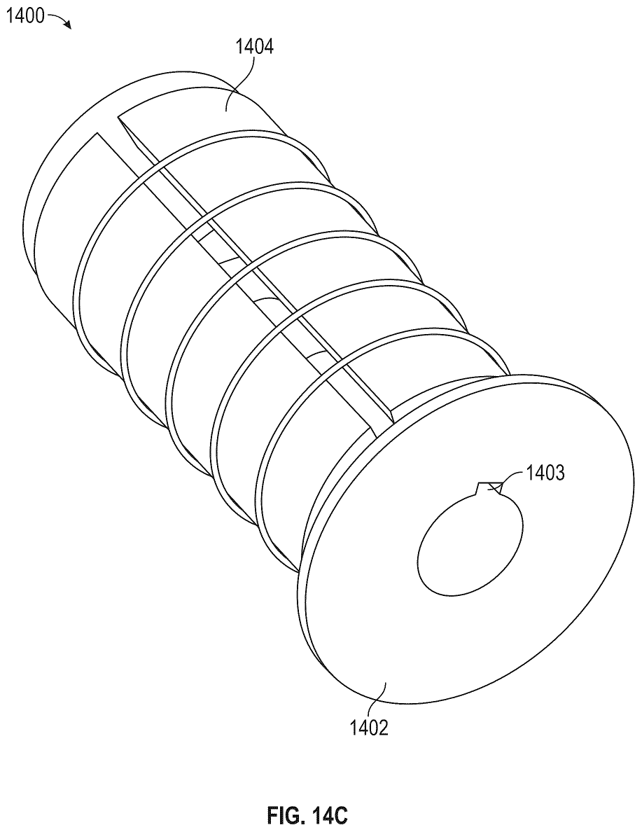

FIG. 13 is a perspective views of the motor 128, and FIGS. 14A-14C are a perspective views of a gripper assembly 1400. The motor 128 is coupled to the gripper assembly 1400. For example, the motor 128 includes a coupling 1302 (e.g., motor shaft, drive shaft, etc.) configured to couple the gripper assembly 1400 to the motor 128.

The gripper assembly 1400 includes a gripper base 1402, a plurality of gripper pads 1404, a gripper shaft 1406, a gripper cap 1408, and a plurality of friction elements 1410 (e.g., elastic rings etc.). The gripper base 1402 is in contact with the base 102. The gripper base 1402 and the gripper cap 1408 are conical and/or tapered. The plurality of gripper pads 1404 are configured to grip (e.g., couple via friction due, at least in part, to the plurality of friction elements 1410, etc.) the second roll 124. The gripper shaft 1406 extends through and is coupled to each of the gripper base 1402 and the gripper cap 1408, collectively referred to herein as an expansion assembly. The plurality of gripper pads 1404 each have tapered ends configured to engage with the conical and/or tapered surface of the gripper base 1402 and the gripper cap 1408. As the gripper cap 1408 is threaded lower onto the gripper shaft 1406, the tapered wedge-shaped surfaces of the gripper base 1402 and gripper cap 1408 engage with the tapered ends of the gripper pads 1404 to transform the vertical motion of the gripper cap 1408 into horizontal motion of the gripper pads 1404, pushing them laterally away from the gripper shaft 1406 and expanding the gripper assembly 1400. In such a way, the gripper assembly 1400 can be expanded when a roll of material is received on the gripper assembly 1400 to secure the roll to the gripper. The gripper shaft 1406 extends through the gripper base 1402, the base 102 and is coupled to the motor 128 (e.g., via a motor shaft, etc.). The gripper shaft 1406 is configured to receive torque from the motor 128 and rotate the gripper assembly 1400 to roll the stepped-backed material 800 onto the second roll 124. The gripper base 1402 may include a keyway 1403 to engage with the gripper shaft 1406 to rotate with the gripper shaft. 1406 as shown in FIG. 14C.

FIG. 14B is a perspective view of the gripper assembly 1400 with on the plurality of gripper pads 1404 removed. As shown in FIG. 14B, the gripper elements 1410 are positioned around the gripper pads 1404 (e.g., compressed, squeezing the gripper pads 1404, etc.) and secure the plurality of gripper pads 1404 to the gripper shaft 1406. The gripper shaft 1406 is rotatably coupled to the gripper base 1402 such that by twisting the gripper shaft 1406, the distance between the gripper base 1402 and the gripper cap 1408 is decreased. The conical shape of each of the gripper base 1402 and the gripper cap 1408 then causes the gripper pads 1404 to move outward stretching the gripper elements 1410 and increasing the grip of the gripper assembly 1400 on the second roll 124.

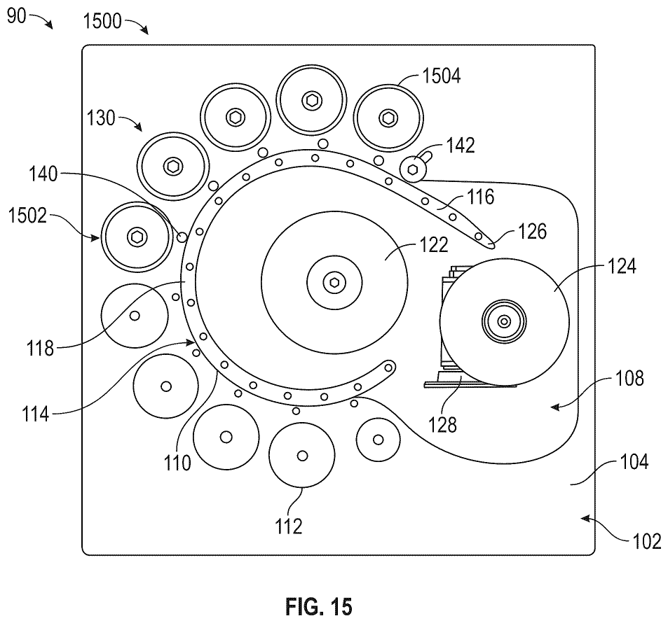

FIGS. 15 and 16 illustrate the apparatus 1500 according to another embodiment. The apparatus 1600 includes five spacers 130, and the five spacers are positioned around about a quarter circle arrangement (e.g., the five spacers 130 are positioned around half of the curved portion 118 of the guide plate 114, etc.). According to this embodiment, the spacers 130 are substantially the same height such that each raised portion height H is substantially the same.

Of the five spacers 130, only a first spacer 1502 and a second spacer 1504 are rotatably supporting rolls of tape 132. The first spacer 1502 and the second spacer 1504 are not adjacent such that there are a plurality of spacers 130 positioned between the first spacer 1502 and the second spacer 1504.

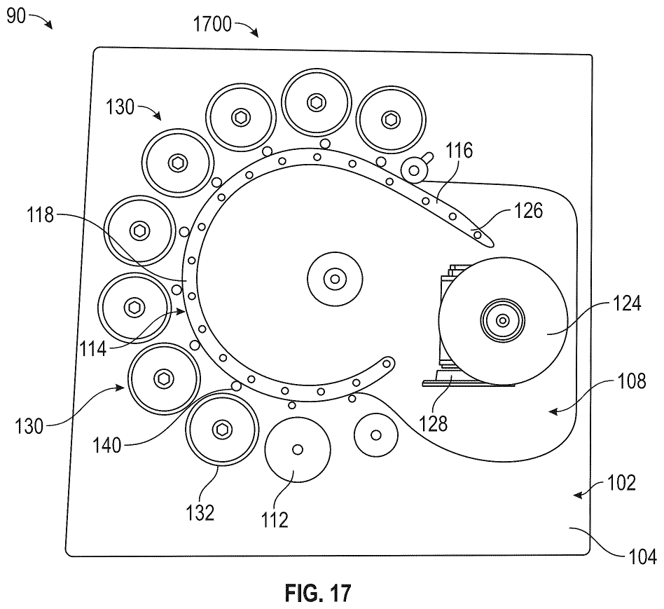

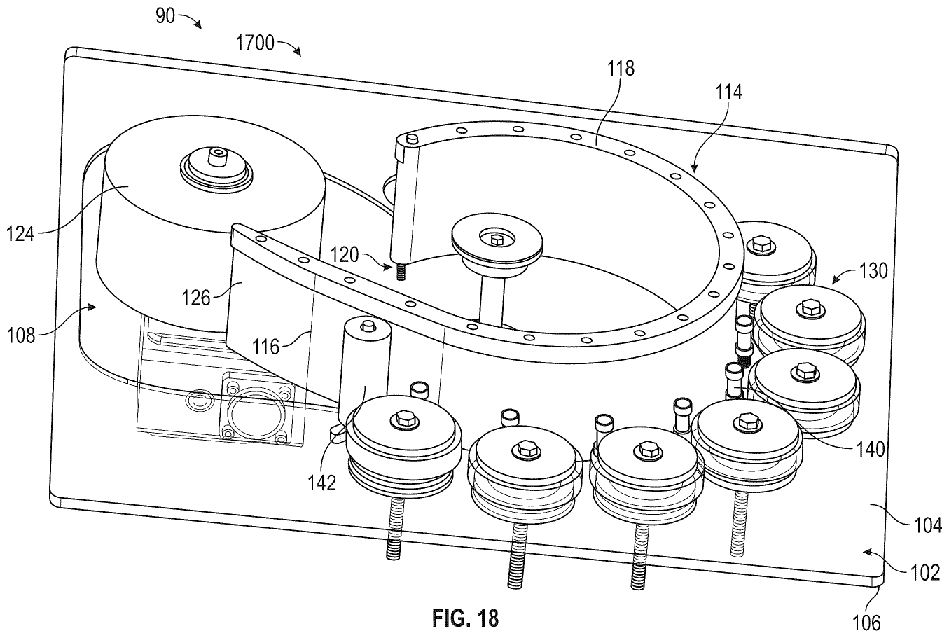

FIGS. 17 and 18 illustrate the apparatus 1700. According to this embodiment, the apparatus 1700 includes eight spacers 130, but is not limited thereto. As such, any combination of number of spacers 130 and number of rolls of tape 132 is possible such that the spacers 130 and rolls of tape are interchangeable. A first spacer 1702 and a second spacer 1704 of the spacers 130 are rotatably coupled to rolls of tape 132. As shown in FIG. 17, the second spacer 1704 is positioned a spaced apart from the first spacer 1702 such that a plurality of spacers 130 are positioned between the first spacer 1702 and the second spacer 1704 (e.g., six spacers between the first spacer 1702 and the second spacer 1704, etc.) and of the spacers 130 are rotatably coupled to rolls of tape 132.

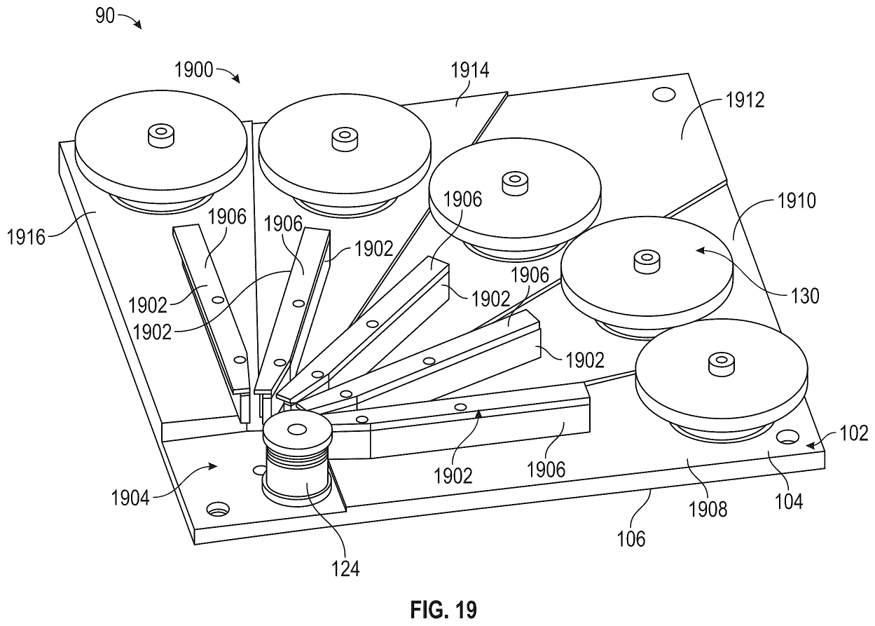

FIG. 19 illustrates the apparatus 1900 according to yet another embodiment. As shown in FIG. 19, the apparatus 1900 includes a plurality of guide plates 1902. Each of the plurality of guide plates 1902 corresponds to one of the spacers 130. For example, according to this embodiment, the apparatus 1900 includes five spacers 130 and five guide plates 1902.

According to this embodiment, the guide plates 1902 extend radially outward from a corner 1904 of the apparatus 100. The guide plates 1902 are substantially straight and include a tapered end 1906. The tapered end 1906 is positioned adjacent to the second roll 124.

Further, as shown in FIG. 19, each of the spacers 130 are positioned on a section 1908, 1910, 1912, 1914, 1916 of the base 102. The base 102 varies in thickness such that each of the sections 1908, 1910, 1912, 1914, 1916 varies comprises a different height. For example, each consecutive section 1908, 1910, 1912, 1914, 1916 has a greater height than the previous section 1908, 1910, 1912, 1914, 1916. For example, a second section 1910 has a height that is greater than a first section 1908. The varying height of the sections 1908, 1910, 1912, 1914, 1916 facilitates providing tapes layers from the plurality of rolls of tape 132 to the second roll 124 at varying heights offsetting the layers. According to this embodiment, the first spacer 130 positioned on the first section 1908 is rotatably coupled to the backing material and the subsequent spacers 130 (e.g., the spacers 130 positioned on the sections 1910, 1912, 1914, 1916) are rotatably coupled to rolls of tape (e.g., tape 132, etc.).

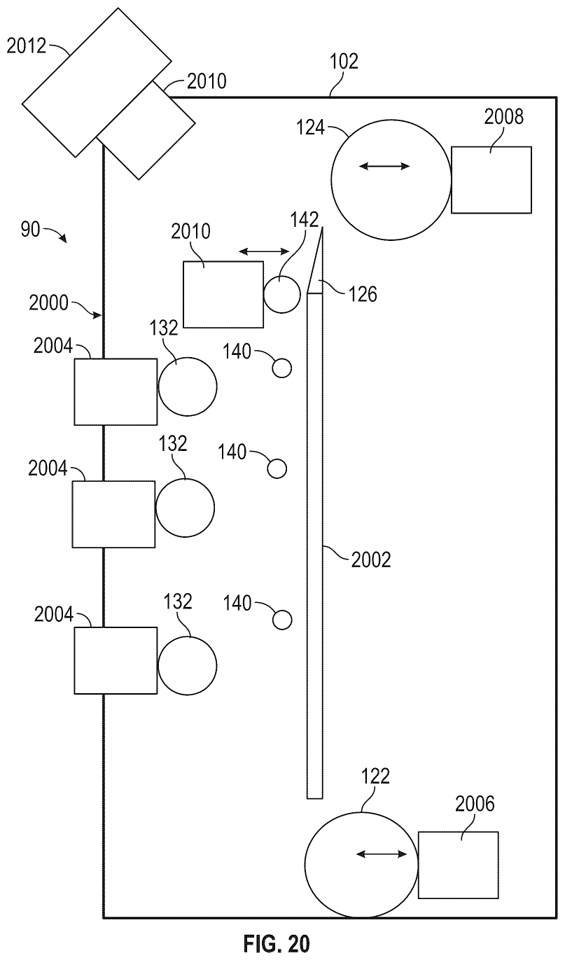

FIG. 20 illustrates the apparatus 2000 according to yet another embodiment. As shown in FIG. 20, the apparatus includes the base 102, the plurality of spacers 130, the plurality of guide pins 140, and the tensioner 142. The apparatus 2000 also includes the guide plate 2002. According to this embodiment, the guide plate 2002 is substantially straight (e.g., flat, not curved, etc.). The guide plate 2002 includes the tapered end 126 that guides the adhesive backed tape 132 on the backing material 802 onto the second roll 124.

The apparatus 2000 also includes a plurality of spacer actuators 2004. Each of the spacer actuators 2004 corresponds to one of the spacers 130. For example, according to this embodiment, each spacer 130 has its own spacer actuator 2004. In other embodiments, a single spacer actuator 2004 may move each of the spacers 130.

The spacer actuators 2004 are configured to adjust a position of each of the spacers 130. The spacer actuators 2004 are configured to move (e.g., adjust, actuate, etc.) a corresponding spacer 130 a distance along the first side 104 of the base 102 (e.g., horizontally, across a plane defined by the base 102, etc.). For example, the spacer actuators 2004 are configured to move the spacers 130 in a direction substantially perpendicular to the guide plate 2002. As the rolls (e.g., rolls of tape 132, etc.) decrease in diameter (e.g., are used up, etc.), the spacer actuators 2004 are configured to move the spacers 130 including the tape rolls, towards the guide plate such that a distance (e.g., a threshold distance, etc.) between the guide pin 140 and the spacer 130 is maintained. Before or soon after a new roll of tape 132 is placed on the spacer 130, the spacer actuator 2004 is configured to move the spacer 130 a distance away from the guide plate 2002 (e.g., back to a starting distance, etc.) such that the distance (e.g., a threshold distance, etc.) from an outer edge of the roll of tape 132 to the guide pin 140 is maintained.

In some embodiment, the spacers 130 may be movable, by the spacer actuators 2004, in a vertical direction (e.g., a direction orthogonal to the base 102, etc.). As such, the height in which the tape 132 is provided to (e.g., guided onto, etc.) the backing material 802 is adjustable.

The apparatus 2000 also includes a first roll actuator 2006, and a second roll actuator 2008. The first roll actuator 2006 is configured to move the first roll 122 of backing material 802 a distance across the first side 104 of the base 102 (e.g., horizontally, across a plane defined by the base 102, etc.). For example, as a diameter of the first roll 122 decreases as backing material 802 is fed onto the guide plate 2002, the first roll actuator 2006 is configured to move the first roll 122 in a direction towards the guide plate 2002. According to some embodiments, the direction may be substantially perpendicular to the guide plate 2002. In some embodiments, the outer edge of the first roll 122 may be moved by the first roll actuator 2006 such that the outer edge of the first roll 122 be substantially parallel to the guide plate 2002.

Similarly, the second roll actuator 2008 is configured to move the second roll 124 a distance across the first side 104 of the base 102 (e.g., horizontally, across a plane defined by the base 102, etc.). For example, as a diameter of the second roll 124 increases as the adhesive tape (e.g., including the backing material 802, and the tape 132, etc.) is fed onto the second roll 124, the second roll actuator 2008 is configured to move the second roll 124 in a direction away from the guide plate 2002 to accommodate the increasing diameter of the second roll 124. For example, the second roll 124 can be moved such that the distance from an outer edge of the second roll 124 and the tapered end 126 of the guide plate 2002 remains constant (e.g., at a minimum distance, at a threshold distance, etc.).

In some embodiments, each of the first roll actuator 2006 and the second roll actuator 2008 are configured to move (e.g., adjust, actuate, etc.) the first roll 122 and the second roll 124, respectively, to accommodate rolls of varying tape widths.

The apparatus 200 also includes a camera system 2050 and a camera control system 2052. The camera system 2050 is configured to monitor (e.g., capture images, etc.) the According to this embodiment, the camera system 2050 is positioned near the tensioner 142 and the second roll 124 such that the camera system 2410 captures images and/or video of the stepped-backed material 800 positioned on the backing material 802 as the stepped-backed material 800 positioned on the backing material 802 is being pulled from (e.g., rolled on, etc.) the tapered end 126 to the second roll 124.

According to this embodiment, the camera control system 2052 is positioned adjacent to the camera system 2010. In other embodiments, the camera control system 2052 is positioned a distance away from the camera system 2050 and the camera system 2050 is communicably coupled to the control system via a wireless network (e.g., Bluetooth, Wi-Fi, etc.). As such, the camera control system 2052 can be a remote-control system that facilitates remote monitoring and control of the system 90.

The camera control system 2052 includes a screen (e.g., a display, etc.). The screen is configured to display the images and/or video captured by the camera system 2010. The camera control system 2052 also includes a memory and processor such that the camera control system 2052 can store data (e.g., images, and video, etc.) and receive input commands. The processor can be implemented as a general purpose processor, an application specific integrated circuit (ASIC), one or more field programmable gate arrays (FPGAs), a group of processing components, or other suitable electronic processing components. The memory (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory can be or include volatile memory or non-volatile memory. The memory can include database components, object code components, script components, or any other type of information structure for supporting the various activities and information structures described in the present application. According to some embodiments, the memory is communicably connected to processor via a processing circuit and includes computer code for executing (e.g., by the processing circuit and/or the processor) one or more processes described herein. For example, the user may view the video data of the stepped-backed material 800 in real time (e.g., from a remote position, etc.) and provide an input that causes the motor 128 of the system 90 to start, stop, slow down, or speed up. The user may also provide an input command to the camera control system 2052 that causes one or more of the spacer actuators 2004, the first roll actuator 2006, and the second roll actuator 2008 to move a distance away from or a distance towards the guide plate 2002.

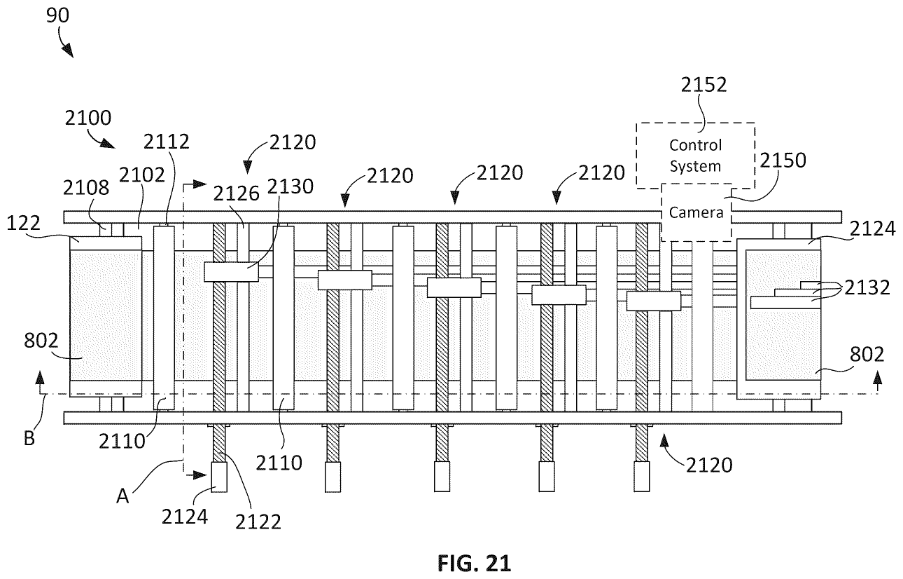

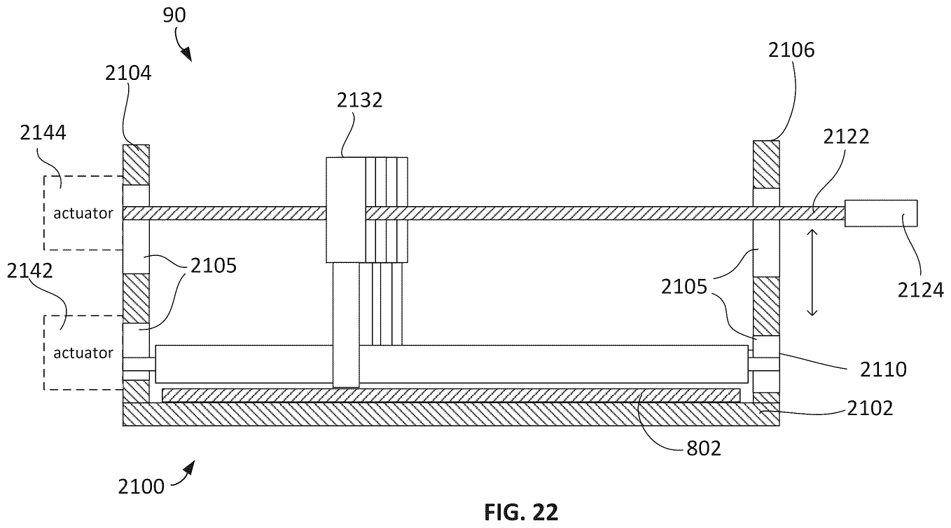

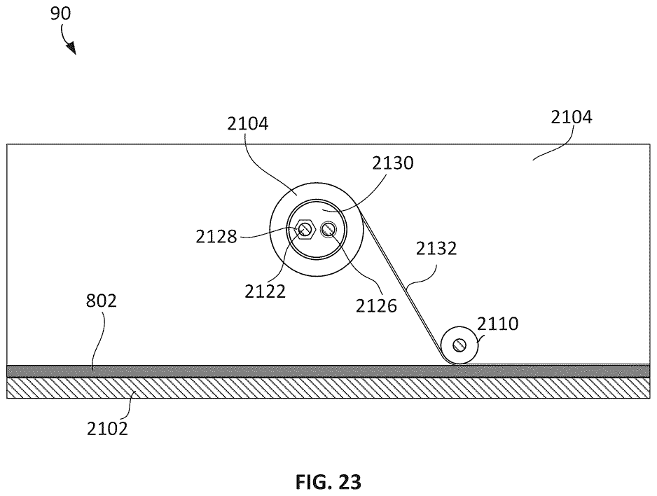

Now referring to FIGS. 21-23 is the system 90 according to another embodiment. FIG. 21 illustrates a top down view of the system 90. FIG. 22 is a cross sectional view of the system 90 at line A. FIG. 23 is a cross sectional view of system 90 at line B. The system 90 includes the apparatus 2100 including the base 2102. According to this embodiment, the base 2102 is substantially rectangular in shape and elongated in the longitudinal direction. For example, the apparatus 2100 is configured to facilitate manufacturing a range of stepped-backed materials 800 including large scale stencils. Extending vertically from each side of the base 2102 are walls including a first wall 2104 and a second wall 2106. At a first end of the system 90 the first roll 122 containing a wound sheet of backing material 802 is rotatably supported by a first roll rod 2108 extending between the first wall 2104 and the second wall 2106. The first roll rod 2108 may be a dowel, shaft, or axle around which the first roll 122 rotates. In some embodiments, between the first roll 122 and the first roll rod 2018 is positioned a gripper assembly (e.g., gripper assembly 1400) which can grip and capture the first roll 122, and together the first roll 122 and the gripper assembly rotate around the first roll rod 2108. In some embodiments, the first roll rod 2108 extends entirely across the base 2101 between the first wall 2104 and the second wall 2106. In some embodiments, the first roll rod 2108 is split into two segments, and each segment supports and end of the first roll 122 and/or the gripper assembly.

Extending from the first roll 122 is a sheet of backing material 802. The sheet of backing material 802 extends down from the first roll 122 where it is turned by a guide roller 2110 until the backing material 802 runs substantially parallel and adjacent to the base 2102. The guide roller 2110 rotates around a center shaft 2112. In some embodiments, the guide roller 2110 may be fixedly coupled to the center shaft 2112 and stationary, such that the backing material 802 moves against the guide roller 2110.

Positioned along the length of the apparatus 2100 after the guide roller 2110 are a plurality of tape dispensing assemblies 2120. Each of the tape dispensing assembly 2120 includes a first threaded shaft 2122, a second shaft 2126, and a tape holder 2130. The first threaded shaft 2122 is rotatably coupled to the first wall 2104 and the second wall 2106 and includes a handle 2124 at an exposed end of the first threaded shaft 2122. The tape holder 2130 is threadably coupled to the first threaded shaft 2122 and slidably coupled to the second shaft 2126. A nut 2128 is fixedly coupled to the tape holder 2130 and includes a threaded internal bore. The threaded internal bore of the nut 2128 engages with the first threaded shaft 2122, thereby threadably coupling the first threaded shaft 2122 with the tape holder 2130. In operation, rotation of the threaded rod by a user gripping the handle 2124 causes the tape holder 2130 to slide along the length of the first threaded shaft 2122. In this way, when the roll of tape (e.g., tape 2132 etc.) is provided around the tape holder 2130, a user can adjust the lateral of the tape 2132 between the first wall 2104 and the second wall 2106 by twisting the first threaded shaft 2122 and moving the tape holder 2130. For stability, and to provide a counteracting force such that the tape holder 2130 translates rather than rotates with the first threaded shaft 2122, the tape holder 2130 is also slidably coupled to the second shaft 2126. The second shaft 2126 extends between the first wall 2104 and the second wall 2106. The first threaded shaft 2122 and the second shaft 2126 are each offset from a center of the tape holder 2130, though in other embodiment one of the first threaded shaft 2122 or the second shaft 2126 may be in the middle of the tape holder 2130 with the other being offset.

The tape 2132 from the roll of tape on the tape holder 2130 extends down towards the backing material 802 on the base 2102. The tape 2132 may be the same as tape 132. A guide roller 2110 positioned after the tape dispensing assembly 2120 changes applies a force to the tape 2132 to press the tape 2132 down on the backing material 802 such that the tape 2132 and backing material form the first part of a stepped-back material. The system 90 includes a plurality of tape dispensing assemblies 2120 to provide additional layers of tape, each successive layer of tape 2132 at least partially overlapping the previous layer. Each of the tape dispensing assemblies are positioned at different lateral positions between the first wall 2104 and the second wall 2106 to form the stepped-backed material. The amount of overlap between each tape dispensing assembly 2120 can be adjusted by rotation of the corresponding threaded shafts first threaded shaft 2122. In some embodiments, there is a gap between layers of tape 2132 such that they do not overlap, and two or more separate stepped-back materials are created in a single pass. For example, there may be ten tape dispensing assemblies 2120 in the system 90, and a subset of the plurality (e.g., two, three, four, five, etc.) may overlap with each other, and corresponding subset of the plurality (e.g., eight, seven, six, five, etc.) may overlap each other, but the subsets themselves may not overlap. There may be multiple subsets of non-overlapping groups of layered tape.

As shown in FIG. 22, the apparatus 2100 may optionally include one more actuators for adjusting the height of the first roll 122, the tape 2132, or the guide rollers 2110. Each of the supporting rods or shafts (e.g., first roll rod 2108, center shaft 2112, first threaded shaft 2122, and/or second shaft 2126) may be positioned in a vertical slot 2105 of the first wall 2014 and the second wall 2106, allowing the rods or shafts to translate vertically. The actuators (e.g., actuator 2142, actuator 2144) may be coupled to an end of one or more of the rods or shafts for adjusting the position of the rods or shafts in the vertical slots actuators 2114. According to this embodiment, the actuators (e.g., actuator 2142, actuator 2144) are configured to move the rod or shaft of a corresponding to the roll of tape 2132 a distance in a direction perpendicular to the base 2102. For example, the actuators (e.g., actuator 2142, actuator 2144) can move the guide roller 2110 closer to or further away from the base 2102 to account for varying thicknesses for the of rolls of tape 2132, or to adjust the amount of force applied to the tape 2132.

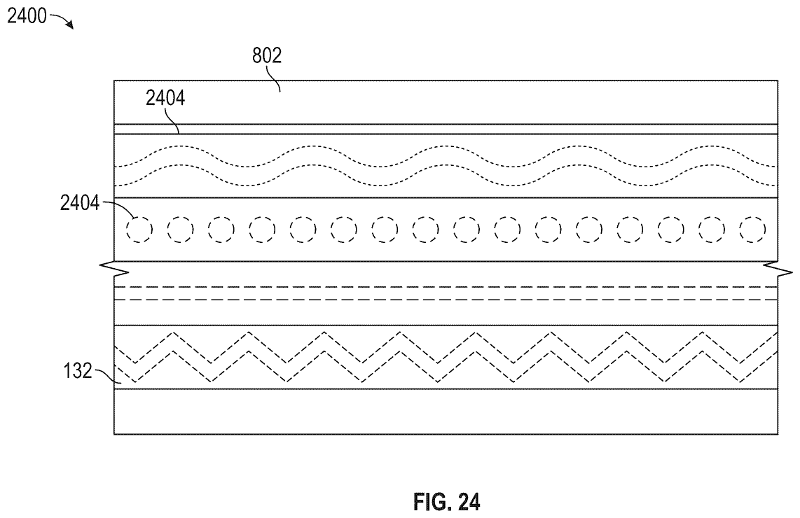

Now referring to FIG. 24 is an illustration of the stepped-backed material 2400 according to another embodiment. The stepped-backed material 2400 is a stencil. For example, a first layer of tape 2402 (e.g. a layer adjacent to the backing material 802, etc.) defines a plurality of cutouts 2404 (e.g., laser cut, etc.). Each successive layer of tape 132 covers a portion of the cutouts 2404. As the user removes a layer of tape 132 a portion of the cutouts 2404 is exposed for applying a coating (e.g., paint, etc.). While shown as each layer of tape covering a discrete arrangement of cutouts 2404, in some embodiments the cutouts 2404 in each layer of tape 132 are coextensive or aligned, such that the cutouts 2404 work together to form a single cohesive image like a mural. In some embodiments, the tape 132 of each layer may therefore entirely overlap the underlying layer of tape, except for any cutouts 2404. After paint is applied over the first layer of tape 132, the first layer of tape 132 can be removed to reveal more parts of the image, which are then exposed for paint in a second layer. The process can be repeated to create a single image with multiple layers of paint.

As utilized herein, the terms “approximately,” “about,” “substantially”, and similar terms are intended to include any given ranges or numbers+/−10%. These terms include insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. An apparatus comprising:
a base;
a guide plate coupled to a first side of the base, the guide plate comprising:
a substantially straight portion,
a curved portion extending away from a first end of the substantially straight portion and defining a guide plate cavity;
a plurality of spacers coupled to the first side of the base and positioned a distance away from an outer edge of curved portion of the guide plate, each of the spacers rotatably supporting a roll of tape;
a plurality of guide pins coupled to the first side of the base, each of the guide pins positioned between a corresponding spacer and the outer edge of the curved portion of the guide plate;
a first roll comprising a first material, the first roll removably coupled to the first side of the base and positioned in the guide plate cavity, the first roll configured to receive tape; and
a second roll removably coupled to the first side of the base and positioned adjacent to a second end of the straight portion, the second roll configured to receive the tape coupled to the first material.

2. The apparatus of claim 1, further comprising:
a motor coupled to a second side of the base and aligned with the second roll, the motor configured to rotate the second roll.

3. The apparatus of claim 2, wherein the first material is a paper backing configured to receive the tape, and wherein the second roll is configured to receive the tape coupled to the first material and wind the tape and the first material around the second roll as the second roll rotates.

4. The apparatus of claim 1, wherein each of the spacers comprises a raised portion and a recessed portion, at least one of the raised portions comprising a raised portion height different from the height of an adjacent raised portion.

5. The apparatus of claim 4, wherein each roll of tape is positioned in the recessed portion of each of the spacers.

6. The apparatus of claim 5, wherein the raised portion height of a first spacer of the plurality of spacers is set such that the tape from the first spacer is provided to overlap with half of the tape of an adjacent spacer of the plurality of spacers when coupled to the first material.

7. The apparatus of claim 5, wherein the raised portion heights of each of the spacers successively increases in a direction clockwise around the curved portion of the guide plate.

8. The apparatus of claim 7, wherein each of the plurality of guide pins comprises a guide pin height proportional to the raised portion height of the corresponding spacer.

9. The apparatus of claim 8, wherein the guide pin height is substantially equal to the raised portion height.

10. The apparatus of claim 1, further comprising a tensioner coupled to the first side of the base and positioned adjacent to an outer side of the substantially straight portion of the guide plate, the tensioner configured to apply a force to the tape and the first material pressing the tape and the first material against the guide plate.

11. The apparatus of claim 10, wherein the tensioner is adjustably coupled to the first side of the base such that a distance between the tensioner and the substantially straight portion of the guide plate is adjustable.

12. A method of manufacturing a stepped-backed material, the method comprising:
providing a portion of a first tape roll to a first material at a first height;
coupling the portion of the first tape roll to the first material by feeding each of the first tape roll and the first material between a first guide pin and a guide plate;
providing a portion of a second tape roll to the first material at a second height;
coupling the portion of the second roll of tape to the first material by feeding each of the second tape roll and the first material comprising the portion of the first tape roll between a second guide pin and the guide plate; and
receiving, by a pin, the first material comprising each of the portion of the first tape roll and the portion of the second tape roll.

13. The method of claim 12, wherein the second height is set such that the portion of the second tape roll overlaps the first portion of the first tape roll.

14. The method of claim 12, wherein receiving the first material comprising each of the portion of the first tape roll and the portion of the second tape roll, comprising rotating, by a motor, the pin causing the first material comprising each of the portion of the first tape roll and the portion of the second tape roll to wind around the pin.

15. The method of claim 12 further comprising:
providing a portion of a third tape roll to the first material at a third height;
coupling the portion of the third tape roll to the first material by feeding each of the third tape roll and the first material comprising the portion of the first tape roll and the portion of the second tape roll between a third guide pin and the guide plate;
providing a portion of a fourth tape roll to the first material at a fourth height; and
coupling the portion of the fourth tape roll to the first material by feeding each of the fourth tape roll and the first material comprising the portion of the first tape roll, the portion of the second tape roll, and the portion of the third tape roll between a fourth guide pin and the guide plate.

16. The method of claim 15, wherein the fourth height is greater than the third height, and the third height is greater than each of the second height and the first height.

17. An apparatus comprising:
a base;
a first roll of backing material;
a plurality of rolls of tape each coupled to the base and configured to provide a layer of tape to the backing material;
a second roll configured to receive a first end of the first roll of backing material, the second roll coupled to a motor configured to rotate the second roll,
wherein rotation of the second roll pulls the backing material from the first roll and tape from each of the plurality of rolls of tape into contact with the backing material of the first roll.

18. The apparatus of claim 17, further comprising at least one tensioner configured to press at least one of the plurality of rolls of tape into contact with the backing material of the first roll as the second roll rotates.

19. The apparatus of claim 17, wherein the apparatus further comprises:
a plurality of tape holders, each of the plurality of tape holders configured to support a roll of the plurality of rolls of tape, each tape holder of the plurality of tape holders comprising:
a first threaded shaft threadably coupled to the tape holder; and
a second shaft slidably coupled to the tape holder, such that rotation of the threaded shaft causes the tape holder to translate along the first threaded shaft and the second shaft.

20. The apparatus of claim 17, at least one of the plurality of rolls of tape is offset from another of the plurality of rolls of tape such that the tape from the at least one of the plurality of rolls of tape is at least partially overlapped by the tape of the other of the plurality of rolls of tape.
